(19) United States
(12) Patent Application Publication
(10) Pub. No.: US 2012/0242782 A1
(43) Pub. Date: Sep. 27, 2012

(54) IMAGE CAPTURE DEVICE AND IMAGE PROCESSING METHOD

(75) Inventor: JYUN-HAO HUANG, Tu-Cheng (TW)

(73) Assignee: HON HAI PRECISION INDUSTRY CO., LTD., Tu-Cheng (TW)

(21) Appl. No.: 13/246,873

(22) Filed: Sep. 28, 2011

(30) Foreign Application Priority Data
Mar. 24, 2011 (TW) 100110069

(51) Int. Cl. H04N 5/225

(52) U.S. Cl. 348/36; 348/E05.024

(57) ABSTRACT

A method for processing an image captured by a fisheye lens of an image capture device. The method obtains a point (Px, Py) from an object plane of the fisheye lens, calculates a first projection point (Fx*, Fy*, Fz*) of the obtained point (Px, Py) on a first image plane of a virtual lens, calculates a second projection point (Fx, Fy) of the point (Fx*, Fy*, Fz*) on a second image plane of the fisheye lens, and obtains transforming formulae between (Px, Py) and (Fx, Fy). The method further obtains a back-projection point for each point of the captured image on the object plane of the fisheye lens according to the transforming formulae, and creates an updated image of the specified scene from the back-projection points.

### BACKGROUND

1. Technical Field

Embodiments of the present disclosure relate to security surveillance technology, and particularly to an image capture device and image processing method using the image capture device.

2. Description of Related Art

Image monitoring systems have been used to perform security surveillance by capturing images of monitored scenes using cameras, and sending the captured images to a monitor computer. The majority of these systems use either a fixed-mount camera with a limited viewing field, or they utilize mechanical pan-and-tilt platforms and mechanized zoom lenses to orient the camera and magnify the image. Fisheye lenses can be used to provide wide-angle viewing of a monitored scene. However, the images captured by the fisheye lenses are distorted in comparison with normal lenses, thereby adversely influencing the monitoring effectiveness. Therefore, an efficient method for processing an image captured by a fisheye lens of an image capture device is desired.

### BRIEF DESCRIPTION OF THE DRAWINGS

FIG. 1 is a block diagram of one embodiment of an image capture device.

FIG. 2 is a block diagram of function modules of an image processing system included in the image capture device of FIG. 1.

FIG. 3 is a flowchart of one embodiment of a method for processing an image captured by the image capture device of FIG. 1.

FIG. 4 is an exemplary schematic diagram of a fisheye lens in a two dimensional (2D) space.

FIG. 5 is an exemplary schematic diagram of an imaging model of the fisheye lens in a 2D space.

FIG. 6 is a first exemplary schematic diagram of a fisheye lens in a three dimensional (3D) space.

FIG. 7 is a second exemplary schematic diagram of a fisheye lens in a 3D space.

FIG. 8 is an exemplary schematic diagram of a first imaging model of the fisheye lens in a 3D space when an object plane of the fisheye lens is located in a first position.

FIG. 9 is an exemplary schematic diagram of a back-projected image on the object plane of the fisheye lens using the first imaging model in FIG. 8.

FIG. 10 is an exemplary schematic diagram of a second imaging model of the fisheye lens in a 3D space when the object plane of the fisheye lens is located in a second position.

FIG. 11 is an exemplary schematic diagram of a back-projected image on the object plane of the fisheye lens using the second imaging model in FIG. 10.

FIG. 12 is an exemplary schematic diagram of a virtual lens outside the fisheye lens of the image capture device.

FIG. 13 is an exemplary schematic diagram of the projection on an image plane of the virtual lens.

FIG. 14 is an exemplary schematic diagram of the projection on an image plane of the fisheye lens.

FIG. 15 is an exemplary schematic diagram of a geometrical model of the projection points of the object plane onto the image plane of the virtual lens.

FIG. 16 is an exemplary schematic diagram of an angular control of a tilting movement of the fisheye lens.

FIG. 17 is an exemplary schematic diagram of an angular control of a panning movement of the fisheye lens when the fisheye lens is installed on a ceiling.

FIG. 18 is an exemplary schematic diagram of an angular control of a panning movement of the fisheye lens when the fisheye lens is installed on a wall.

FIG. 19 is an exemplary schematic diagram of a simplified model of the geometrical model in FIG. 15.

FIG. 20 is an exemplary schematic diagram of a geometrical model of the projection points of the image plane of the virtual lens onto an image plane of the fisheye lens.

### DETAILED DESCRIPTION

All of the processes described below may be embodied in, and fully automated via, functional code modules executed by one or more general purpose electronic devices or processors. The code modules may be stored in any type of non-transitory readable medium or other permanent storage device. Some or all of the methods may alternatively be embodied in specialized hardware. Depending on the embodiment, the non-transitory readable medium may be a hard disk drive, a compact disc, a digital video disc, a tape drive or other suitable storage medium.

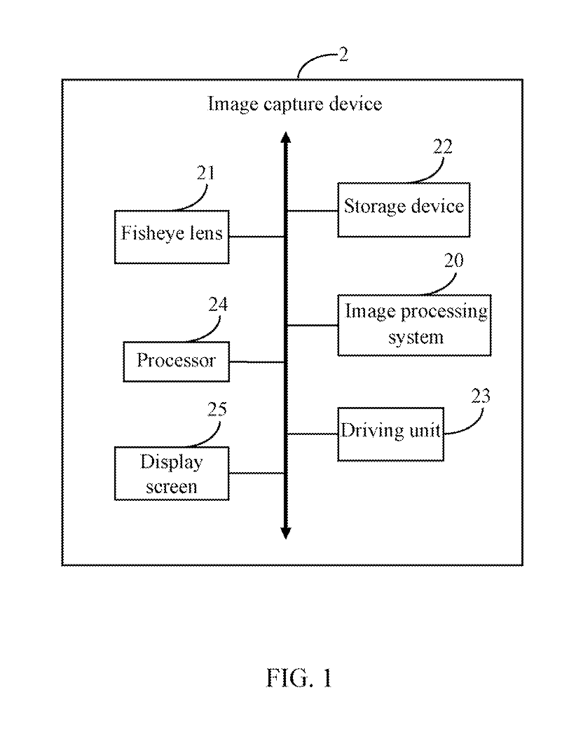

FIG. 1 is a block diagram of one embodiment of an image capture device 2. In one embodiment, the image capture device 2 includes an image processing system 20, a fisheye lens 21, a storage device 22, a driving unit 23, at least one processor 24, and a display screen 25. The image processing system 20 may be used to process images captured by the fisheye lens 21 to remove distortion effects from the captured images.

In one embodiment, the image capture device 2 may be a speed dome camera or a pan/tilt/zoom (PTZ) camera. The fisheye lens 21 is operable to capture a plurality of images of a specified scene. In one embodiment, the specified scene may be the interior of a warehouse or other high-security locations. The driving unit 23 may be used to aim, focus, and zoom the fisheye lens 21. In one embodiment, the driving unit 23 may include one or more motors.

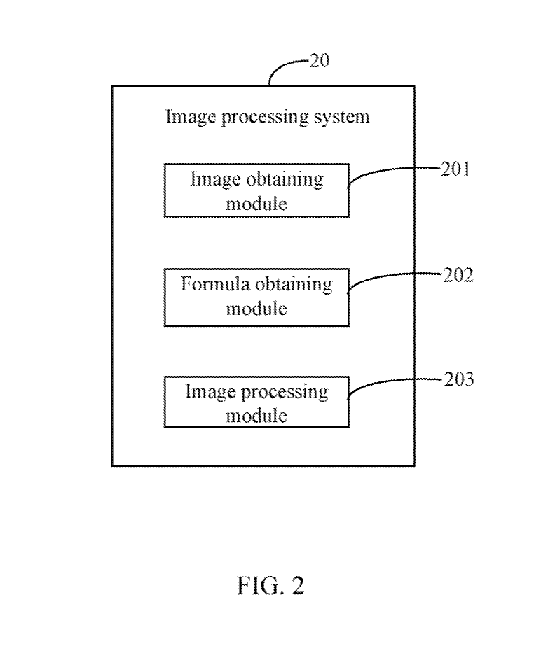

FIG. 2 is a block diagram of one embodiment of the image processing system 20 of the image capture device 2. In one embodiment, the image processing system 20 may include one or more modules, for example, an image obtaining module 201, a formula obtaining module 202, and an image processing module 203. The one or more modules 201-203 may comprise computerized code in the form of one or more programs that are stored in the storage device 22 (or memory). The computerized code includes instructions that are executed by the at least one processor 24 to provide functions for the one or more modules 201-203.

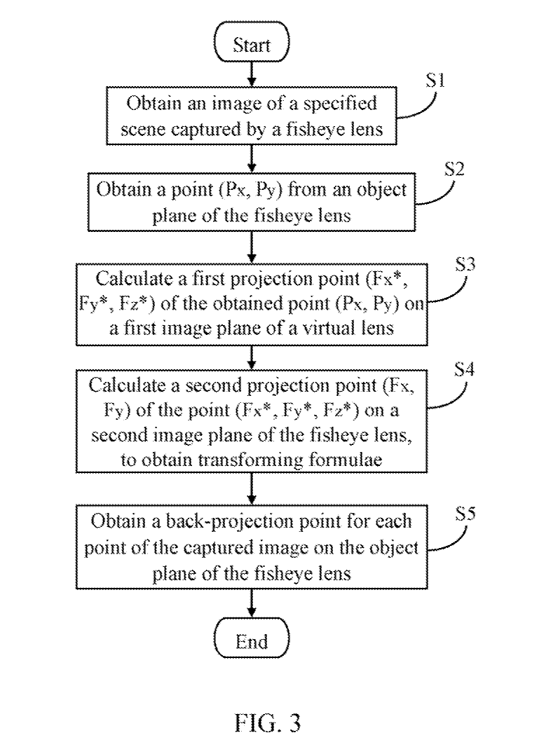

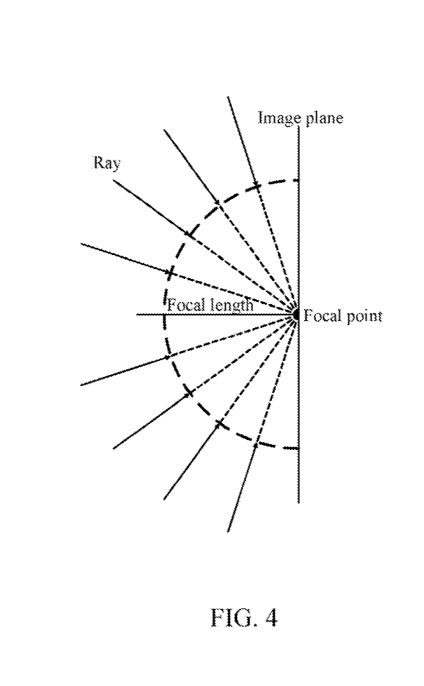

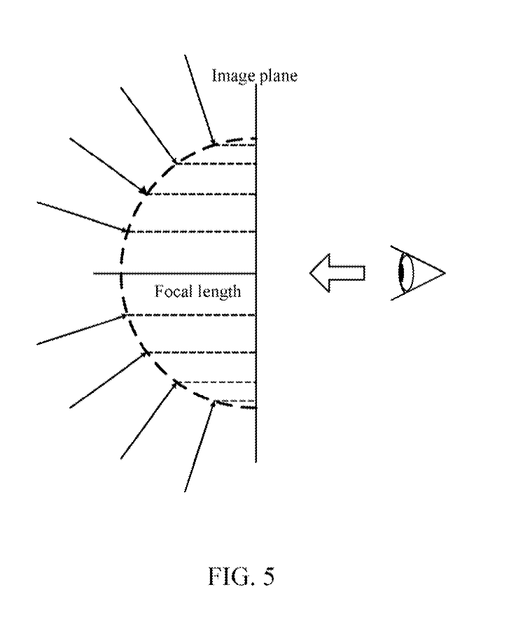

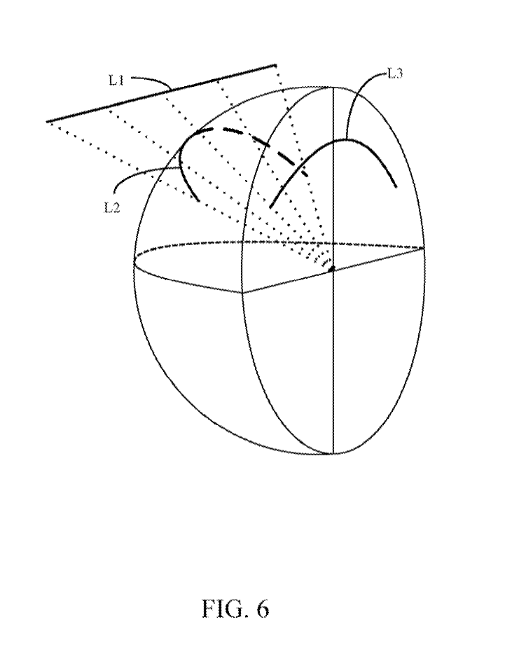

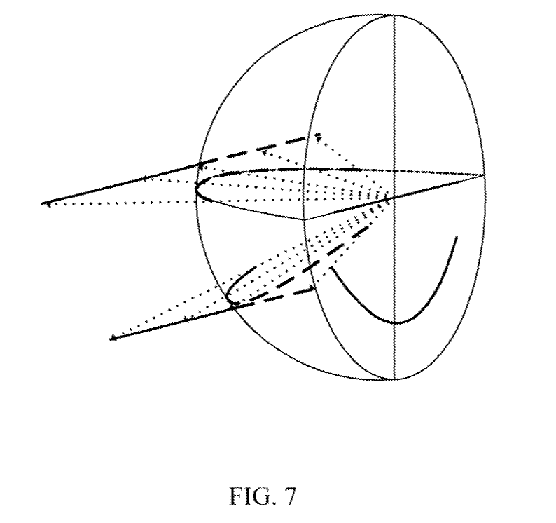

An image forming principle of the fisheye lens 21 is introduced before describing FIG. 3. As shown in FIG. 4 and FIG. 5, light rays are firstly projected onto an outer surface of the fisheye lens 21, and further projected onto an image plane of the fisheye lens 21. As shown in FIG. 6, suppose that “L1” represents a straight line in a three dimensional (3D) space, “L2” represents a projected figure on the outer surface of the fisheye lens 21, and “L3” represents a projected figure on the image plane of the fisheye lens 21. Another example is shown in FIG. 7. As revealed in FIG. 6 and FIG. 7, the projected figures on the image plane of the fisheye lens 21 are distorted.

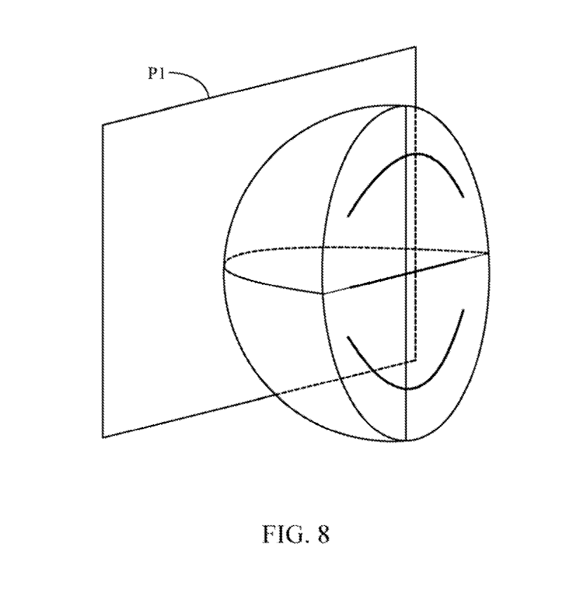

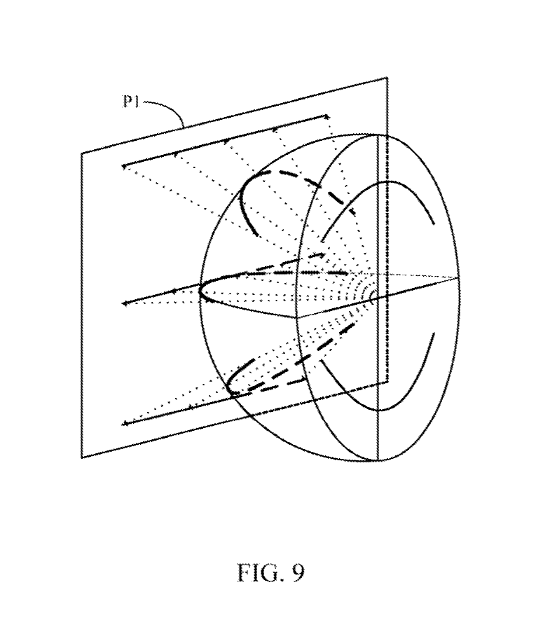

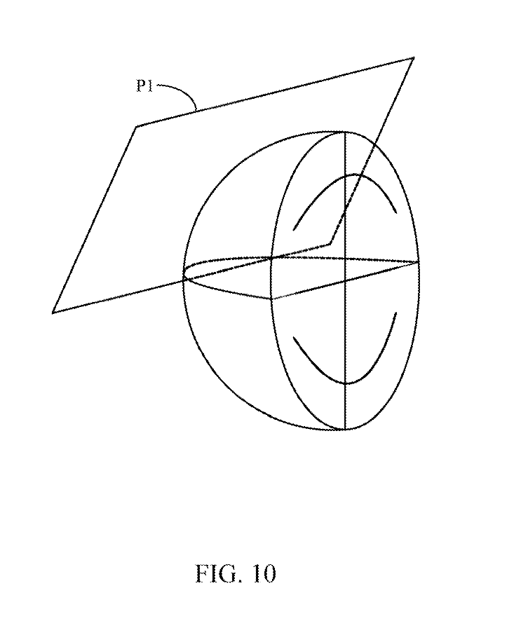

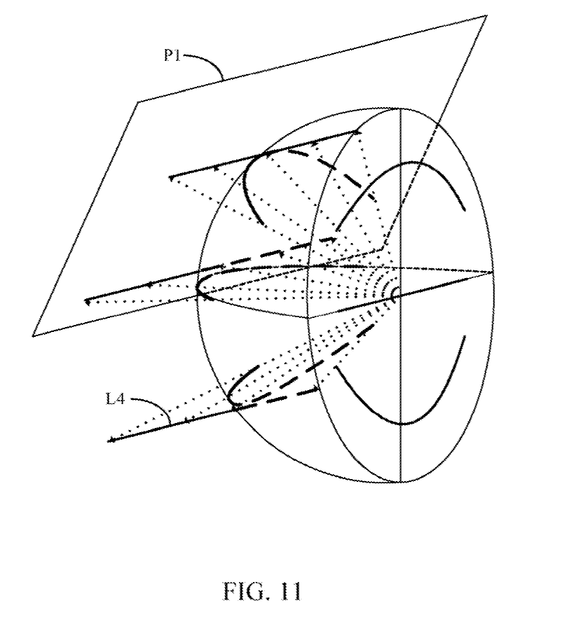

Using back-projection operation, the points in the image plane of the fisheye lens 21 can be restored to an original or undistorted state. As shown in FIG. 8, suppose that “P1” represents an object plane of the fisheye lens 21 in a 3D space, then an exemplary schematic diagram of the back-projected image on the object plane of the fisheye lens 21 is shown in FIG. 9. If the object plane “P1” is located in a second position as shown in FIG. 10, an exemplary schematic diagram of the back-projected image on the object plane of the fisheye lens 21 is shown in FIG. 11. As shown in FIG. 11, the straight line “L4” is outside the object plane “P1,” thus, the straight line “L4” cannot be restored using a back-projection operation.

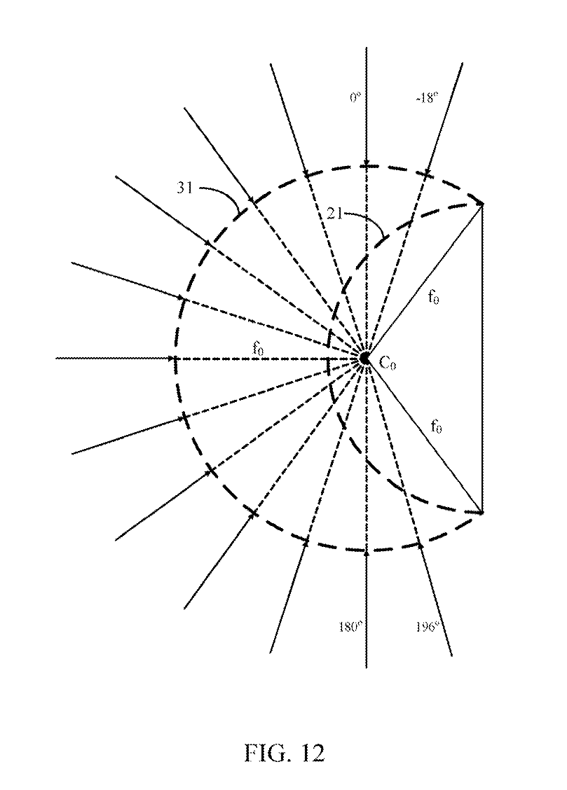

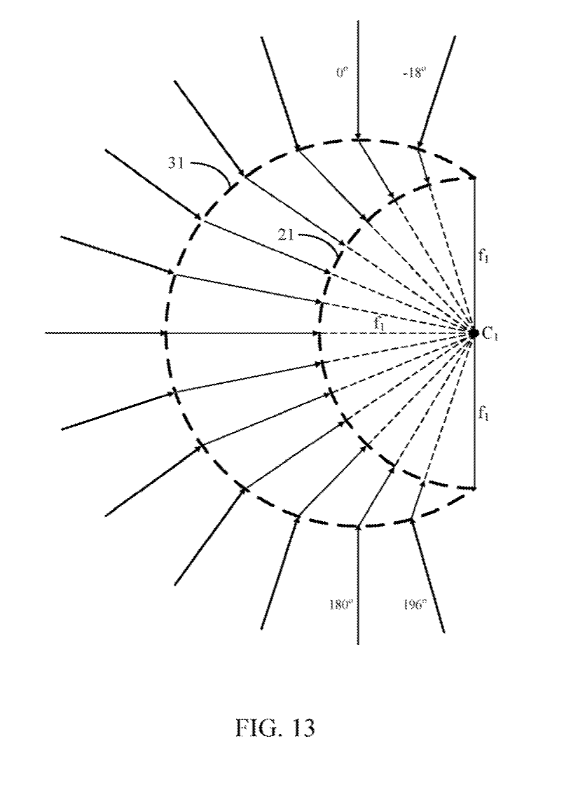

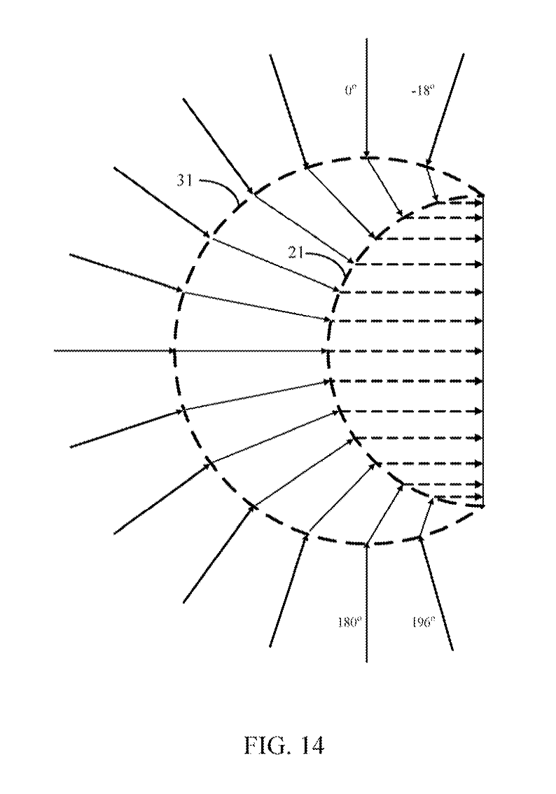

As shown in FIG. 12, in this embodiment, to remove any distortions from captured images on the image plane of the fisheye lens 21, a virtual lens 31 is hypothetically located outside the fisheye lens 21. In one embodiment, a central angle of the virtual lens 31 may be greater than 180 degrees. As shown in FIG. 12, “C₀” represents a focal point of the virtual lens 31, and “f₀” represents a focal length of the virtual lens 31. As shown in FIG. 13, “C₁” represents a focal point of the fisheye lens 21, and “f₁” represents a focal length of the fisheye lens 21. Light rays are firstly projected onto an image plane of the virtual lens 31 (as shown in FIG. 13), and further projected onto the image plane of the fisheye lens 21 (as shown in FIG. 14).

As shown in FIG. 14, the rays whose incidence angle is greater than 180 degrees or less than 0 degrees can also be projected onto the image plane of the fisheye lens 21. The viewing field of the fisheye lens 21 can be broadened by adjusting the distance between the focal point “C₀” of the virtual lens 31 and the focal point “C₁” of the fisheye lens 21.

FIG. 3 is a flowchart of one embodiment of a method for processing an image captured by the image capture device 2. Depending on the embodiment, additional blocks may be added, others removed, and the ordering of the blocks may be changed.

In block S1, the image obtaining module 201 obtains an image of the specified scene captured by the fisheye lens 21. In one embodiment, the fisheye lens 21 captures an image of the specified scene at preset time intervals (e.g., five seconds).

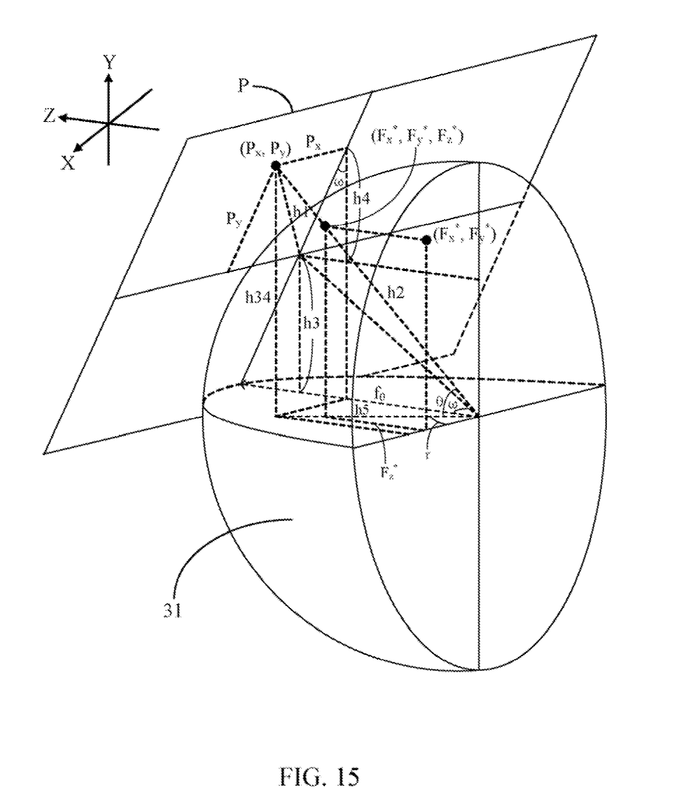

In block S2, the formula obtaining module 202 obtains a point (Px, Py) from the object plane of the fisheye lens 21. In one example (as shown in FIG. 15), the point (Px, Py) is obtained from the object plane of the fisheye lens 21.

In block S3, the formula obtaining module 202 calculates a first projection point (Fx*, Fy*, Fz*) of the obtained point (Px, Py) on the image plane (hereinafter referred to as “first image plane”) of the virtual lens 31. An exemplary schematic diagram of a geometrical model of the projection points of the object plane onto the image plane of the virtual lens 31 is shown in FIG. 15. In one embodiment, the first projection point (Fx*, Fy*, Fz*) is calculated by applying the formulae (1)-(11).

h1=\sqrt{Px²++Py²} (1)

h2=\sqrt{h1²+f₀²} (2)

h3=f₀*sin( ω) (3)

h4=P_{y}*cos(ω) (4)

h34=h3+h4 (5)

$$θ = {sin}^{- 1} ( \frac{h 34}{h 2} ) \qquad ( 6 )$$

h5=h2*cos(θ) (7)

$$τ = {cos}^{- 1} ( \frac{Px}{h 5} ) \qquad ( 8 )$$

Fy*=f₀*sin(θ) (9)

Fx*=f₀*cos(θ) cos(τ) (10)

Fz*=f₀*cos(θ) sin(τ) (11)

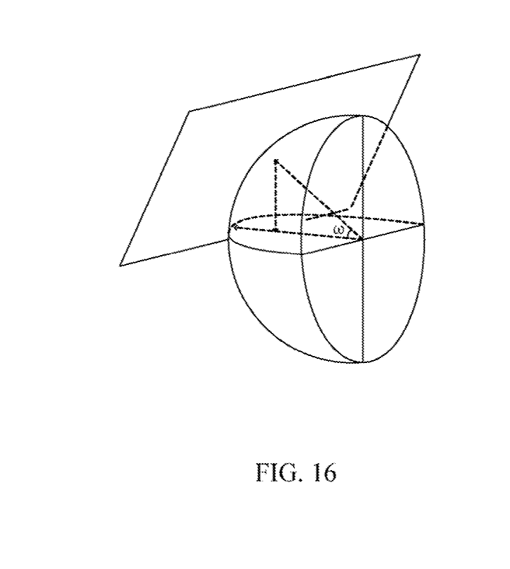

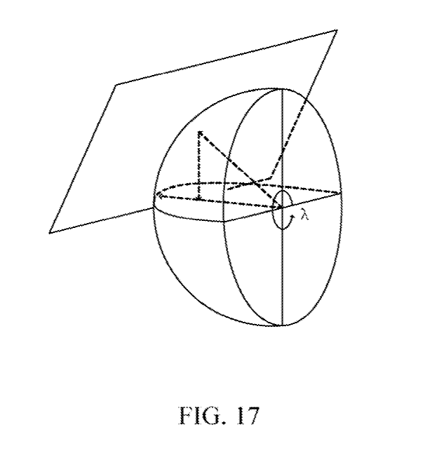

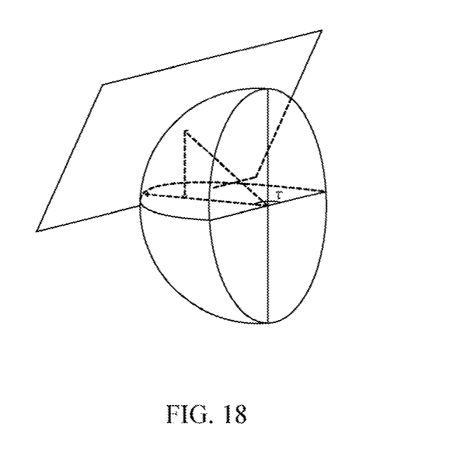

In the above formulae, “f₀” represents the focal length of the virtual lens 31, “ω” represents an angle used to control a tilting movement of the fisheye lens 21 (as shown in FIG. 16), and “τ” represents an angle used to control a panning movement of the fisheye lens 21 when the fisheye lens 21 is installed on a wall (as shown in FIG. 18). In another embodiment, if the fisheye lens 21 is installed on a ceiling, the panning movement of the fisheye lens 21 is controlled by adjusting the angle “λ” (as shown in FIG. 17). The zooming operation (e.g., zoom in/zoom out) of the images captured by the fisheye lens 21 may be controlled using the Bilinear algorithm or other suitable image processing methods.

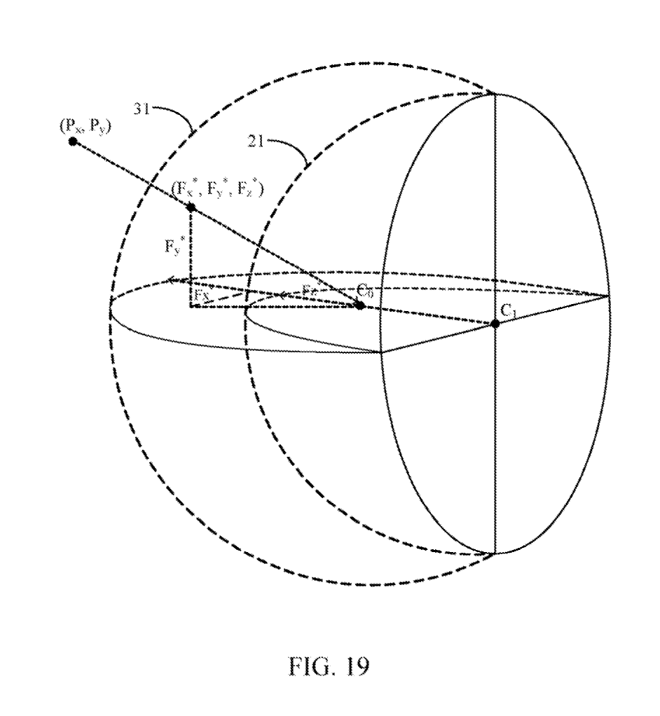

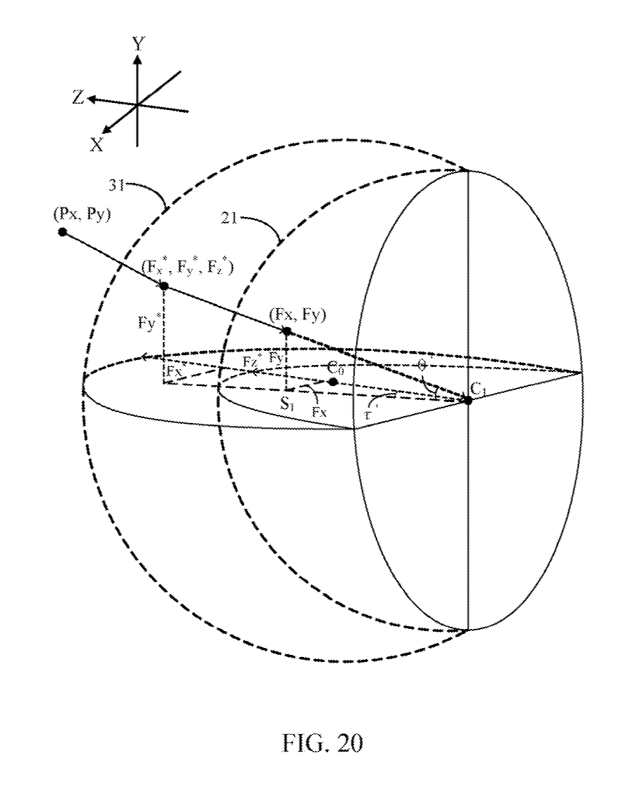

In block S4, the formula obtaining module 202 calculates a second projection point (Fx, Fy) of the point (Fx*, Fy*, Fz*) on an image plane (hereinafter referred to as “the second image plane”) of the fisheye lens 21, and obtains transforming formulae from the point (Px, Py) on the object plane of the fisheye lens 21 to the point (Fx, Fy) on the second image plane of the fisheye lens 21. As shown in FIG. 19, the point (Fx*, Fy*, Fz*) represents the projection point of the point (Px, Py) on the first image plane of the virtual lens 31. An exemplary schematic diagram of a geometrical model of the projection points of the first image plane onto the second image plane is shown in FIG. 20. In one embodiment, the second projection point (Fx, Fy) is calculated by the formulae (12)-(17).

Δ=F_{z}*+|C₁−C₀| (12)

$$\begin{matrix}{τ}^{′} = {tan}^{- 1} ( \frac{{Fx}^{*}}{Δ} ) & ( 13 ) \\ {S}_{1} = \frac{{Fx}^{*}}{sin ( {τ}^{′} )} & ( 14 ) \\ {θ}^{′} = {tan}^{- 1} ( \frac{{Fy}^{*}}{{S}_{1}} ) & ( 15 )\end{matrix}$$

F_{y}=f₁*sin(θ′) (16)

Fₓ=f₁*cos(θ′) sin(τ′) (17)

In the above formulae, “C₀” represents the focal point of the virtual lens 31, “C1” represents the focal point of the fisheye lens 21, and “f₁” represents the focal length of the fisheye lens 21. Thus, each point in the captured image of the second image plane of the fisheye lens 21 can be back-projected onto the object plane of the fisheye lens 21 using all of the above formulae (1)-(17), so as to the captured image.

In block S5, the image processing module 203 obtains a back-projection point for each point of the captured image on the object plane of the fisheye lens 21 according to the transforming formulae (1)-(17), and creates an updated image of the specified scene from the back-projection points, so that any distortion in the obtained image is removed when the updated image of the specified scene is displayed on the display screen 25.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for processing an image captured by an image capture device comprising a fisheye lens, the method comprising:
obtaining an image of a specified scene captured by the fisheye lens of the image capture device;
obtaining a point (Px, Py) from an object plane of the fisheye lens;
calculating a first projection point (Fx*, Fy*, Fz*) of the obtained point (Px, Py) on a first image plane of a virtual lens outside the fisheye lens;
calculating a second projection point (Fx, Fy) of the point (Fx*, Fy*, Fz*) on a second image plane of the fisheye lens;
obtaining transforming formulae from the point (Px, Py) on the object plane of the fisheye lens to the point (Fx, Fy) on the second image plane of the fisheye lens;
obtaining a back-projection point for each point of the captured image on the object plane of the fisheye lens according to the transforming formulae; and
creating an updated image of the specified scene from the back-projection points, and displaying the updated image of the specified scene on a display screen of the image capture device.

2. The method according to claim 1, wherein the first projection point (Fx*, Fy*, Fz*) is calculated by following formulae:
h1=\sqrt{Px²+Py²} (1)
h2=\sqrt{h1²+f₀²} (2)
h3=f₀*sin(ω) (3)
h4 =P_{y}*cos(ω) (4)
h34=h3+h4 (5)
$$θ = {sin}^{- 1} ( \frac{h 34}{h 2} ) \qquad ( 6 )$$
h5=h2*cos(θ) (7)
$$τ = {cos}^{- 1} ( \frac{Px}{h 5} ) \qquad ( 8 )$$
Fy*=f₀*sin(θ) (9)
Fx*=f₀*cos(θ) cos(τ) (10)
Fz*=f₀*cos(θ) sin(τ) (11)
wherein “f₀” represents a focal length of the virtual lens outside the fisheye lens, and “ω” represents an angle used to control a tilting movement of the fisheye lens of the image capture device.

3. The method according to claim 2, wherein the second projection point (Fx, Fy) is calculated by following formulae:
Δ=F_{z}*+|C₁−C₀| (12)
$$\begin{matrix}{τ}^{′} = {tan}^{- 1} ( \frac{{Fx}^{*}}{Δ} ) & ( 13 ) \\ {S}_{1} = \frac{{Fx}^{*}}{sin ( {τ}^{′} )} & ( 14 ) \\ {θ}^{′} = {tan}^{- 1} ( \frac{{Fy}^{*}}{{S}_{1}} ) & ( 15 )\end{matrix}$$
F_{y}=f₁*sin(θ′) (16)
Fₓ=f₁*cos(θ′) sin(τ′) (17)
wherein “C₀” represents a focal point of the virtual lens, “C1” represents a focal point of the fisheye lens, and “f₁” represents a focal length of the fisheye lens.

4. The method according to claim 1, wherein a central angle of the virtual lens is greater than 180 degrees.

5. The method according to claim 1, wherein the image capture device is a speed dome camera or a pan/tilt/zoom (PTZ) camera.

6. An image capture device, comprising:
a fisheye lens;
a display screen;
a storage device;
at least one processor; and
one or more modules that are stored in the storage device and are executed by the at least one processor, the one or more modules comprising instructions:
to obtain an image of a specified scene captured by the fisheye lens;
to obtain a point (Px, Py) from an object plane of the fisheye lens;
to calculate a first projection point (Fx*, Fy*, Fz*) of the obtained point (Px, Py) on a first image plane of a virtual lens outside the fisheye lens;
to calculate a second projection point (Fx, Fy) of the point (Fx*, Fy*, Fz*) on a second image plane of the fisheye lens, and obtain transforming formulae from the point (Px, Py) on the object plane of the fisheye lens to the point (Fx, Fy) on the second image plane of the fisheye lens; and
to obtain a back-projection point for each point of the captured image on the object plane of the fisheye lens according to the transforming formulae, and create an updated image of the specified scene from the back-projection points, and display the updated image of the specified scene on the display screen.

7. The image capture device according to claim 6, wherein the first projection point (Fx*, Fy*, Fz*) is calculated by following formulae:
h1=\sqrt{Px²+Py²} (1)
h2=\sqrt{h1²+f₀²} (2)
h3=f₀*sin(ω) (3)
h4=P_{y}*cos(ω) (4)
h34=h3+h4 (5)
$$\begin{matrix}θ = {sin}^{- 1} ( \frac{h 34}{h 2} ) & ( 6 ) \\ h 5 = h {2}^{*} cos ( θ ) & ( 7 ) \\ τ = {cos}^{- 1} ( \frac{Px}{h 5} ) & ( 8 )\end{matrix}$$
Fy*=f₀*sin(θ) (9)
Fx*=f₀*cos(θ) cos(τ) (10)
Fz*=f₀*cos(θ) sin(τ) (11)
wherein “f₀” represents a focal length of the virtual lens outside the fisheye lens, and “ω” represents an angle used to control a tilting movement of the fisheye lens of the image capture device.

8. The image capture device according to claim 7, wherein the second projection point (Fx, Fy) is calculated by following formulae:
Δ=F_{z}*+|C₁−C₀| (12)
$$\begin{matrix}{τ}^{′} = {tan}^{- 1} ( \frac{{Fx}^{*}}{Δ} ) & ( 13 ) \\ {S}_{1} = \frac{{Fx}^{*}}{sin ( {τ}^{′} )} & ( 14 ) \\ {θ}^{′} = {tan}^{- 1} ( \frac{{Fy}^{*}}{{S}_{1}} ) & ( 15 )\end{matrix}$$
F_{y}=f₁*sin(θ′) (16)
Fₓ=f₁*cos(θ′) sin(τ′) (17)
wherein “C₀” represents a focal point of the virtual lens, “C1” represents a focal point of the fisheye lens, and “f₁” represents a focal length of the fisheye lens.

9. The image capture device according to claim 6, wherein a central angle of the virtual lens is greater than 180 degrees.

10. The image capture device according to claim 6, wherein the image capture device is a speed dome camera or a pan/tilt/zoom (PTZ) camera.

11. A non-transitory storage medium having stored thereon instructions that, when executed by a processor of an image capture device, causes the image capture device to perform a method for processing an image captured by the image capture device, the method comprising:
obtaining an image of a specified scene captured by a fisheye lens of the image capture device;
obtaining a point (Px, Py) from an object plane of the fisheye lens;
calculating a first projection point (Fx*, Fy*, Fz*) of the obtained point (Px, Py) on a first image plane of a virtual lens outside the fisheye lens;
calculating a second projection point (Fx, Fy) of the point (Fx*, Fy*, Fz*) on a second image plane of the fisheye lens;
obtaining transforming formulae from the point (Px, Py) on the object plane of the fisheye lens to the point (Fx, Fy) on the second image plane of the fisheye lens;
obtaining a back-projection point for each point of the captured image on the object plane of the fisheye lens according to the transforming formulae; and
creating an updated image of the specified scene from the back-projection points, and displaying the updated image of the specified scene on a display screen of the image capture device.

12. The non-transitory storage medium according to claim 11, wherein the first projection point (Fx*, Fy*, Fz*) is calculated by following formulae:
h1=\sqrt{Px²+Py²} (1)
h2=\sqrt{h1²+f₀²} (2)
h3=fₒ*sin( ω) (3)
h4=P_{y}*cos( ω) (4)
h34=h3+h4 (5)
$$θ = {sin}^{- 1} ( \frac{h 34}{h 2} ) \qquad ( 6 )$$
h5=h2*cos(θ) (7)
$$τ = {cos}^{- 1} ( \frac{Px}{h 5} ) \qquad ( 8 )$$
Fy*=f₀*sin(θ) (9)
Fx*=f₀*cos(θ) cos(τ) (10)
Fz*=f₀*cos(θ) sin(τ) (11)
wherein “f₀” represents a focal length of the virtual lens outside the fisheye lens, and “ω” represents an angle used to control a tilting movement of the fisheye lens of the image capture device.

13. The non-transitory storage medium according to claim 12, wherein the second projection point (Fx, Fy) is calculated by following formulae:
$$\begin{matrix}{τ}^{′} = {tan}^{- 1} ( \frac{{Fx}^{*}}{Δ} ) & ( 13 ) \\ {S}_{1} = \frac{{Fx}^{*}}{sin ( {τ}^{′} )} & ( 14 ) \\ {θ}^{′} = {tan}^{- 1} ( \frac{{Fy}^{*}}{{S}_{1}} ) & ( 15 )\end{matrix}$$
F_{y}=f₁*sin(θ′) (16)
Fₓ=f₁*cos(θ′) sin(τ′) (17)
wherein “C₀” represents a focal point of the virtual lens, “C1” represents a focal point of the fisheye lens, and “f₁” represents a focal length of the fisheye lens.

14. The non-transitory storage medium according to claim 11, wherein a central angle of the virtual lens is greater than 180 degrees.

15. The non-transitory storage medium according to claim 11, wherein the image capture device is a speed dome camera or a pan/tilt/zoom (PTZ) camera.

16. The non-transitory storage medium according to claim 11, wherein the medium is selected from the group consisting of a hard disk drive, a compact disc, a digital video disc, and a tape drive.
